(19) United States
(12) Patent Application Publication
(10) Pub. No.: US 2012/0312624 A1
(43) Pub. Date: Dec. 13, 2012

(54) POWER STEERING GEAR ASSEMBLY

(75) Inventors: Kevin E. Boyle, Bradenton, FL (US); Paul E. Jacobson, Lafayette, IN (US); Daniel E. Williams, Lebanon, IN (US); Wendell L. Gilbert, Lebanon, TN (US); James R. Johnson, Lafayette, IN (US)

(73) Assignee: TRW Automotive U.S. LLC

(21) Appl. No.: 13/158,495

(22) Filed: Jun. 13, 2011

(51) Int. Cl. B62D 5/12

(52) U.S. Cl. 180/432

(57) ABSTRACT

A power steering gear assembly 10 which is used to turn steerable vehicle wheels 50, 52 includes a piston 20 disposed in a motor cylinder 16. A series 44 of rack teeth are connected with the piston 20. A first tooth space 94 is formed between first and second teeth 80, 76 in the series 44 of rack teeth. The first tooth space 94 has a root portion 126 which includes first and second fillets 132, 136. The first fillet 132 has a larger radius of curvature 130 than the second fillet 136. The first and second fillets 132, 136 have centers of curvature which are both disposed between a central axis 104 of the first tooth space 94 and the second rack tooth 76. The center pinion gear tooth 190 has side surfaces 200 and 202 with intermediate portions 216 and 230 which are offset from continuously curving spatial envelopes 212 and 228 containing tip end portions 208 and 222 and root end portions 210 and 224 of the center pinion gear tooth.

### BACKGROUND OF THE INVENTION

The present invention relates to a new and improved power steering gear assembly and more specifically to a power steering gear assembly having a series of rack teeth connected with a piston.

Power steering gear assemblies of the well-known integral type include a piston which is disposed in a motor cylinder. The piston may have a series of rack teeth which mesh with a pinion gear. The pinion gear is connected with steerable vehicle wheels.

The power (force) which can be transmitted by the power steering gear assembly is, at least to some extent, limited by the strength of the series of rack teeth formed in the piston. The piston may be bored and countersunk to receive an externally threaded follow-up member. The rack tooth at the end of the series of teeth toward the opening through which the follow-up member extends may be weak due to countersinking of the opening and/or stress concentrations at the root portion of the tooth.

### SUMMARY OF THE INVENTION

The present invention relates to a new and improved power steering gear assembly for use in turning steerable vehicle wheels. The power steering gear assembly may include a piston which cooperates with a motor cylinder to form motor cylinder chambers. A valve assembly is operable to control a flow of fluid to the motor cylinder chambers. A follow-up member is connected with the valve assembly and the piston to effect operation of the valve assembly as a function of movement of the piston. A pinion gear is disposed in meshing engagement with a series of rack teeth connected with the piston.

In accordance with one of the features of the invention, a tooth space formed between rack teeth has fillets having radii which are not symmetrical with respect to the central axis of the tooth space. In accordance with another feature of the invention, a tooth of the pinion gear has a side surface area which is offset from a spatial envelope of tip and root end portions of a side surface of the tooth of the pinion gear.

The various features of the invention may be used together, as disclosed herein. Alternatively, the various features may be used separately or in combination with one or more features from the prior art.

### BRIEF DESCRIPTION OF THE DRAWINGS

The foregoing and other features of the present invention will become more apparent to those skilled in the art to which the present invention relates from the following description of preferred embodiments of the invention made with reference to the accompanying drawings, in which:

FIG. 1 is a schematic illustration of a power steering gear assembly constructed in accordance with the present invention;

FIG. 2 is an enlarged fragmentary schematic illustration of a series of rack teeth connected with in a piston in the power steering gear assembly of FIG. 1;

FIG. 3 is an enlarged fragmentary schematic illustration depicting the curvature of fillets at a root portion of a tooth space formed between rack teeth of the series of rack teeth;

FIG. 4 is an enlarged fragmentary illustration of a tooth of a pinion gear which is disposed in meshing engagement with the rack teeth of FIG. 2; and

FIG. 5 is an enlarged fragmentary illustration of a portion of the pinion gear tooth of FIG. 4.

### DESCRIPTION OF SPECIFIC PREFERRED EMBODIMENTS OF THE INVENTION

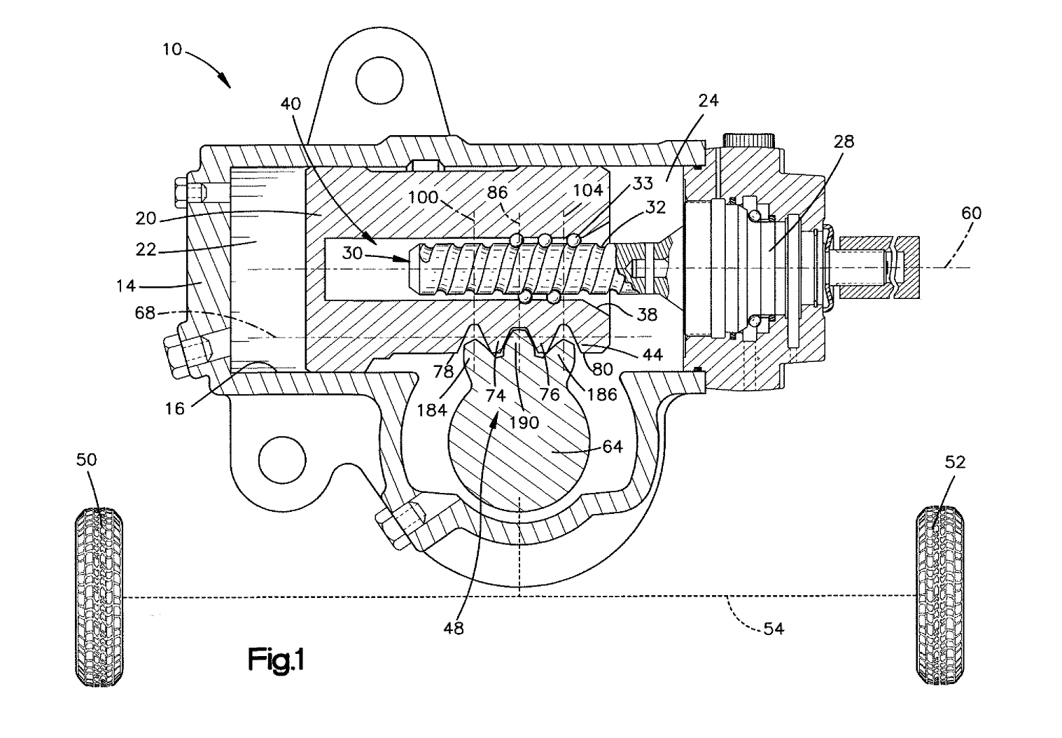

A power steering gear assembly 10 constructed in accordance with the present invention is illustrated schematically in FIG. 1. The power steering gear assembly 10 includes a housing 14 in which a motor cylinder 16 is disposed. A piston 20 is disposed in the housing 14 and cooperates with the motor cylinder 16 to form left and right (as viewed in FIG. 1) motor cylinder chambers 22 and 24.

A valve assembly 28 is disposed in the housing 14 and is connected with the piston 20 by a follow-up member 30. The follow-up member 30 has an external screw thread convolution 32 which cooperates with balls 33 disposed in an internal thread convolution 34 formed in the piston 20. The follow-up member 30 extends through a countersunk circular opening 38 formed in the right (as viewed in FIG. 1) end of the piston 20. A cylindrical bore 40 is formed along the central axis of the piston 20. The internal thread convolution 34 is formed on the inside of the bore 40 and cooperates with the balls 33 to interconnect the follow-up member 30 and the piston 20.

A series 44 of rack teeth are connected with the piston 20. In the embodiment of the invention illustrated in FIG. 1, the rack teeth 44 are machined in the piston 20 so that the rack teeth are integral with and formed by material of the piston. However, the series 44 of rack teeth may be formed separately from the piston 20 and secured to the piston.

A pinion gear 48 is disposed in meshing engagement with the series 44 of rack teeth. The illustrated pinion gear 48 is a sector gear. The pinion or sector gear 48 is connected with steerable vehicle wheels 50 and 52 by a steering linkage 54.

Rotation of a steering wheel (not shown) actuates the valve assembly 28 to change the fluid pressure in the motor cylinder chambers 22 and/or 24. As the fluid pressure in the motor cylinder chambers 22 and/or 24 changes, the piston 20 moves along a straight longitudinal central axis 60 of the power steering gear assembly 10. The axis 60 is coincident with central axes of the motor cylinder 16, piston 20, and follow-up member 30. Axial movement of the piston 20, that is movement of the piston 20 along the axis 60 relative to the housing 14, moves the rack teeth 44 along the axis 60. As this occurs, cooperation between the rack teeth 44 and teeth on the pinion (sector) gear 48 rotates a cross or sector shaft 64 to actuate the steering linkage 54 in a known manner. Actuation of the steering linkage 54 is effective to turn the steerable vehicle wheels 50 and 52.

The linear series 44 of rack teeth has a longitudinal central axis 68 which extends parallel to the longitudinal central axis 60 of the power steering gear assembly 10. The longitudinal central axis 68 of the series 44 of rack teeth is maintained in a parallel relationship with the longitudinal central axis 60 of the power steering gear assembly 10 during movement of the piston 40 in the motor cylinder 16 and during rotation of the pinion gear 48. The general construction and mode of operation of the power steering gear assembly 10 is the same as is disclosed in U.S. Pat. Nos. 3,741,074; 6,546,322, and 7,484,588.

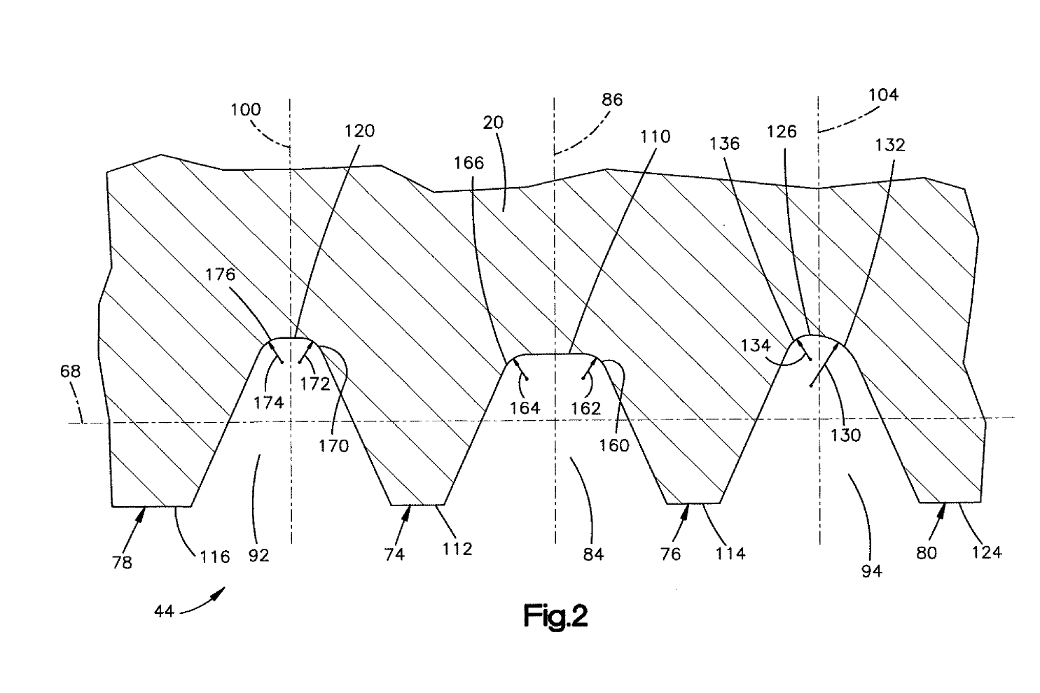

The series 44 of rack teeth includes two fully formed rack teeth 74 and 76 (FIG. 2) and two partially formed rack teeth 78 and 80. The partially formed rack teeth 78 and 80 are disposed at opposite ends of the straight series 44 of rack teeth. It should be understood that the series 44 of rack teeth may include either a greater or lesser number of rack teeth. It should also be understood that the series 44 of rack teeth may include just fully formed rack teeth rather than fully formed and partially formed rack teeth.

A central tooth space 84 (FIG. 2) is formed between rack teeth 74 and 76. The tooth space 84 has a central axis 86 which extends perpendicular to and intersects the longitudinal central axis 68 of the series 44 of rack teeth. The tooth space axis 86 extends perpendicular to and intersects the longitudinal central axis 60 (FIG. 1) of the power steering gear assembly 10. Although the central axis 86 (FIG. 2) of the tooth space 84 intersects and extends perpendicular to the axes 60 and 68 (FIGS. 1 and 2), the central axis 86 of the tooth space 84 may be skewed at an angle to the axes 60 and 68 and may not intersect the axes 60 and 68 if desired.

Similarly, tooth spaces 92 and 94 (FIG. 2) are formed adjacent to opposite ends of the series 44 of rack teeth. The tooth space 92 has a central axis 100 which extends parallel to the central axis 86 of the tooth space 84 and perpendicular to and intersects the longitudinal central axis 68 of the series 44 of rack teeth. Similarly, the tooth space 94 has a central axis 104 which extends parallel to the tooth space axes 86 and 100 and intersects the longitudinal central axis 68 of the series 44 of rack teeth. In the illustrated embodiment, the central axes 86, 100 and 104 of the tooth spaces 84, 92 and 94 extend parallel to each other and perpendicular to both the longitudinal central axis 68 of the series 44 of rack teeth and the central axis 60 of the power steering gear assembly 10.

In the illustrated embodiment, there are three tooth spaces, that is, tooth spaces 84, 92 and 94. If desired, there could be a greater or lesser number of tooth spaces. The tooth space 84 is shallower than the other two tooth spaces. Thus, the distance from a bottom or root portion 110 of the tooth space 84 to the crest (top land) 112 or 114 of the rack teeth 74 or 76, as measured in a direction parallel to the central axis 86 of the tooth space 84, is less than the distance from crest 116 of the tooth 78 or the distance from the crest 112 of the tooth 74 to the bottom or root portion 120 of the tooth space 92, as measured parallel to the central axis 100 of the tooth space 92. The distance from the crest 114 to the rack tooth 76 or the crest 124 of the rack tooth 80 to the bottom or root portion 126 of the tooth space 90 is slightly greater than the distance from the crest 112 or 116 of the tooth 74 or 78 to the bottom or root portion 120 of the tooth space 92 as measured parallel to the central axis 100 of the tooth space 92.

In accordance with one of the features of the present invention, the tooth space 94 is asymmetrical. Thus, the configuration of the portion of the tooth space 94 disposed to the left (as viewed in FIG. 2) of the central axis 104 of the tooth space 94 is different than the configuration of the portion of the tooth space 94 disposed to the right (as viewed in FIG. 2) of the central axis 104 of the tooth space. Although the tooth spaces 84 and 92 are of different sizes, each of these tooth spaces is symmetrical about its central axis. Thus, the tooth space 84 is symmetrical about the axis 86 and the tooth space 92 is symmetrical about the axis 100.

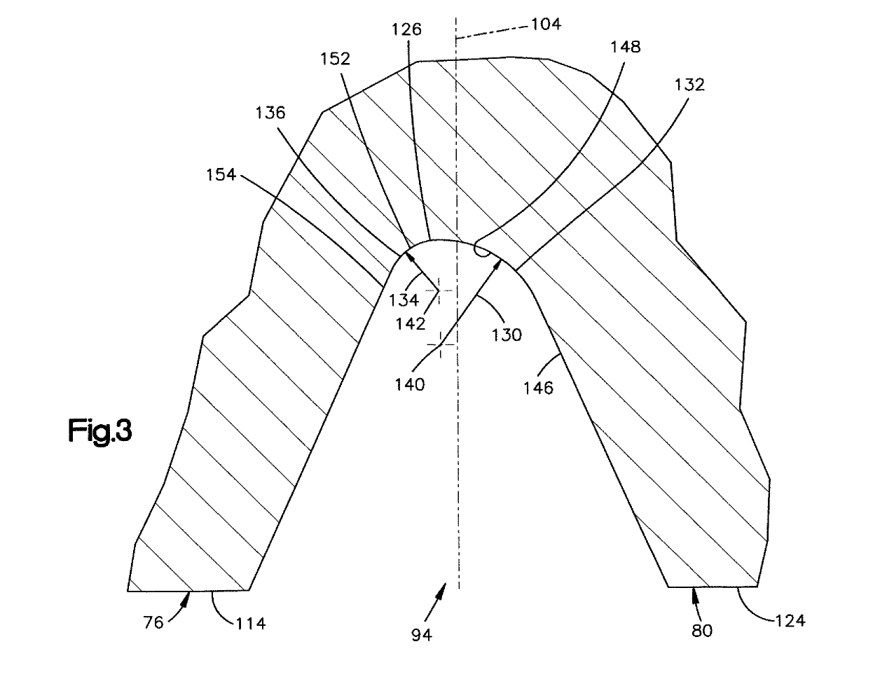

The tooth space 94 is not symmetrical about the axis 104. This is because a radius of curvature 130 of a right (as viewed in FIGS. 2 and 3) fillet 132 is greater than a radius of curvature 134 of a left (as viewed in FIGS. 2 and 3) fillet 136. A center of curvature 140 (FIG. 3) of the right fillet 132 is disposed on the same side of the central axis 104 of the tooth space 94 as a center of curvature 142 (FIG. 3) of the left fillet 136. Thus, the centers of curvature 140 and 142 of the right fillet 132 and left fillet 136 are both offset to the left (as viewed in FIG. 3) of the center line 104 of the tooth space 94.

The right fillet 132 is the concave portion of the profile of the tooth 76, as viewed in a plane extending through the central axis 68 (FIG. 2) of the series 44 of rack teeth and through the central axis 60 (FIG. 1) of the power steering gear assembly 10. The continuously curving right fillet 132 (FIG. 3) extends from the flank of the tooth 80 to the bottom 126 of the tooth space 94. The radius of curvature 130 of the right fillet 132 is such that a continuously curving arcuate side surface 148 of the right fillet is tangential to the flank surface 146 of the tooth 80. In addition, the surface 148 of the right fillet 132 has a smooth line of intersection with a continuously curving surface 152 of the left fillet 136. The bottom or root portion 126 of the tooth space 94 is formed by the two fillets 132 and 136 and does not include a linear surface between the two fillets.

The radius of curvature 134 of the left fillet 136 is smaller than the radius of curvature 130 of the right fillet 132. Therefore, the continuously curving arcuate surface 152 (FIG. 3) of the left fillet 136 is tangential to the flank surface 154 of the tooth 76 at a location closer to the bottom 126 of the tooth space 94 than the location where the surface 148 of the right fillet 132 is tangential to the flank surface 146 of the tooth 80. The continuously curving surfaces 148 and 152 of the right and left fillets 132 and 136 have a smooth line of intersection with each other so that the bottom 126 of the tooth space 94 is free of stress inducing discontinuities.

By forming the surface 148 of the right fillet 132 of the tooth space 94 with a relatively large radius of curvature 130, the amount of metal in the tooth 80 is increased to thereby increase the strength of the tooth 80. Since the right and left fillets 132 and 152 have a smooth surface and continuously curve, there are no discontinuities in the bottom or root portion 126 of the tooth space 94. The material added to the tooth 80 by having a relatively large radius of curvature for the right fillet 132 strengthens the tooth 80 so that a relatively large operating load can be transmitted between the tooth 80 and the pinion gear 48 (FIG. 1).

The tooth spaces 84 and 92 are symmetrical about their central axes 86 and 100 (FIG. 2). Thus, the right fillet 160 for the tooth space 84 has a radius of curvature 162 which is the same as the radius of curvature 164 of a left fillet 166. The centers of curvature of the right and left fillets 160 and 166 of the tooth space 84 are disposed on opposite sides of the central axis 86 of the tooth space 84. By forming the fillets 160 and 166 with equal radiuses of curvature, the bottom or root portion 110 of the tooth space 84 is formed with a symmetrical configuration.

The tooth space 92 is similar to the tooth space 84 except that the tooth space 92 is deeper than the tooth space 84. The tooth space 92 is symmetrical about the central axis 100 of the tooth space. The right fillet 170 of the tooth space 92 has a radius 172 of curvature which is the same as a radius of curvature 174 of the left fillet 176. The centers of curvature of the fillets 170 and 176 of the tooth space 92 are disposed on opposite sides of the central axis 100 of the tooth space 92. By forming the fillets 170 and 176 with equal radiuses of curvature, the bottom or root portion 120 of the tooth space 92 is formed with a symmetrical configuration.

The pinion gear 48 (FIG. 1) has a series of pinion gear teeth which mesh with the series 44 of rack teeth. The series of pinion gear teeth includes left and right end teeth 184 and 186 disposed at opposite ends of the arcuate array of pinion gear teeth. In addition, a center pinion gear tooth 190 is disposed between the end teeth 184 and 186. The end teeth 184 and 186 have the same configuration and cooperate with the tooth spaces 92 and 94 (FIG. 2) in the series 44 of rack teeth in the same manner. However, the center pinion gear tooth 190 is wider than the end teeth 184 and 186 and extends radially outward for a shorter distance than the end teeth 184 and 186 to enable the center tooth 190 to cooperate with the relatively wide and shallow center tooth space 84 in the series 44 of rack teeth.

The pinion or sector gear teeth 184, 186 and 190 (FIG. 1) are axially tapered, that is, in a direction along the longitudinal central axis of the cross or sector shaft 64. The axially tapering configuration of the sector teeth 184, 186 and 190 allows free-play to be removed from between the pinion gear teeth 184, 186 and 190 and the rack teeth 74, 76, 78 and 80 when the steerable vehicle wheels 50 and 52 are in a straight ahead condition. To remove the free-play from between the rack gear teeth 74, 76, 78 and 80 and the pinion gear teeth 184, 186 and 190, the pinion gear is moved axially along the central axis of the cross or sector shaft 64.

The rack teeth 74, 76, 78, and 80 have a constant pitch. However, the pitch radius of the pinion gear teeth 184, 186, 190 increases from a minimum radius at the center tooth 190 to a maximum pitch radius at the end teeth 184 and 186 (FIG. 1). This enables the rate of rotation of the pinion gear 48 to vary with a constant rate of displacement of the rack teeth 44 and piston 20.

The pinion gear teeth 184, 186 and 190 have a relatively large circular thickness to maximize the strength of the pinion gear teeth. In addition, the extent of the pinion gear teeth 184, 186 and 190 along a constant diameter circle, having a radius just slightly greater than the root radius of the pinion gear teeth, is minimized. Minimizing the arcuate extent of the pinion gear teeth allows for the shortest configuration of the rack and pinion with the greatest extent of rotation of the pinion gear 48 about its central axis.

In accordance with one of the features of the present invention, the center tooth 190 (FIG. 1) of the pinion gear 48 has a high-spot on each flank surface of the tooth. These high-spots allow a slight clearance between the pinion gear teeth 184, 186 and 190 and the rack teeth 74, 76, 78 and 80 when the pinion gear 48 is offset from a center condition, that is, when the steerable vehicle wheels 50 and 52 have been turned. This slight clearance is effective to reduce friction between the rack teeth 74, 76, 78 and 80 and the pinion gear teeth 184, 186 and 190 when the steerable vehicle wheels 50 and 52 are not in a straight ahead condition. This reduction in friction between the gear teeth enables the pinion gear 48 and rack to return to a straight ahead condition. The extent of the high-spots along the flanks of the center tooth 190 of the pinion gear 48 is such that each high-spot extends from a constant steering ratio region to a variable steering ratio region of the center gear tooth 190.

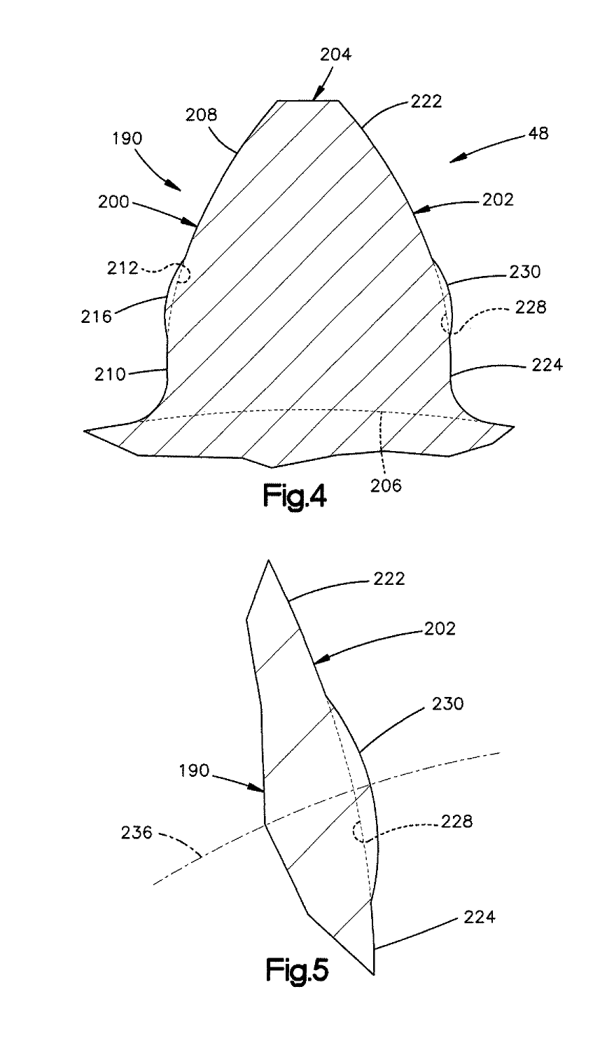

The center gear tooth 190 is illustrated schematically in FIG. 4. The center tooth 190 of the pinion gear 48 includes left and right side surfaces 200 and 202 which extend between a tip end 204 and a root end 206 of the center tooth 190.

The left side surface 200 (FIG. 4) of the center tooth 190 has a tip end portion 208 adjacent to the tip end 204 of the center tooth. The left side surface 200 of the center tooth 190 has a root end portion 210 adjacent to the root end 206 of the center tooth. The tip end portion 208 and root end portion 210 of the left side surface are formed as part of a continuously curving spatial envelope 212. An intermediate or high-spot portion 216 of the left side surface 200 is disposed between the tip end portion 208 and the root end portion 210. The intermediate portion 216 of the side surface 200 of the center tooth 190 is offset from the continuously curving spatial envelope 212 in a direction away from the right side surface 202 of the center tooth 190.

Similarly, the right side surface 202 (FIG. 4) of the center tooth 190 has a tip end portion 222 and a root end portion 224. The continuously curving right side surface 202 has a continuously curving spatial envelope 228. An intermediate portion 230 of the right side surface 202 is disposed between the tip end portion 222 and root end portion 224 of the right side surface. The intermediate portion 230 of the right side surface 202 is offset from continuously curving spatial envelope 228 containing the tip end portion 222 and root end portion 224 of the right side portion 202 in a direction away from the left side surface 200.

The intermediate portion 230 of the right side surface 202 is illustrated schematically in FIG. 5. The distance between the spatial envelope 228 and the intermediate portion 230 of the right side portion 202 has been exaggerated somewhat in FIG. 5 for purposes of clarity of illustration. The extent of the intermediate portion 230 of the right side portion 202 is such that the center of the intermediate portion 230 is disposed on a pitch line 236 of the center tooth 190 of the pinion gear 48 when the steerable vehicle wheels 50 and 52 (FIG. 1) are disposed in a straight ahead condition. The intermediate portion 230 of the right side surface 202 remains on the pitch line 236 as the pinion gear 48 is turned through approximately three (3) to five (5) degrees from an initial or straight ahead condition of the steerable vehicle wheels 50 and 52 and the steering gear assembly 10.

Although the intermediate portion 230 for only the right side 202 of the center tooth 190 of the pinion gear 48 is illustrated schematically in FIG. 5, it should be understood that the intermediate portion 216 of the left side portion 230 of the center tooth 190 has the same configuration, except that it is a mirror image, as the intermediate portion 230 of the right side surface 202. The two intermediate portions 216 and 230 provide high-spots across the center tooth 190 of the pinion gear 48. The two high-spots formed by the intermediate portions 216 and 230 of the side surfaces 200 and 202 of the center tooth 190 provide for a reduction in friction between the pinion gear teeth and the rack teeth when the pinion gear has been turned through a short distance, for example three to five degrees, from an on center or straight ahead condition. The reduction in friction between the gear teeth enables the gear teeth to easily return to an on center or straight ahead condition.

The tip end portion 208 of the left side surface 200 of the center tooth 190 (FIG. 4) is formed as a series of tip end portion involute curves. Similarly, the root end portion 210 of the left side surface 200 of the center tooth 190 is formed as a series of root end portion involute curves. The tip end portion involute curves forming the tip end portion 208 of the center tooth 190 have base circles with diameters which are different than the diameters of the base circles forming the root end portion involute curves. The involute curves forming the root end portion 210 and tip end portion 208 of the left side surface 200 form portions of the continuously curving spatial envelope 212.

The tip end portion 222 of the right side surface 202 of the center tooth 190 is formed as a series of tip end portion involute curves. Similarly, the root end portion 224 of the right side surface 202 of the center tooth 190 is formed as a series of root end portion involute curves. The involute curves forming the root end portion 224 of the right side surface 202 have base circle diameters which are different than the base circle diameters of the involute curves forming the tip end portion 222 of the right side surface 202. The involute curves forming the root end portion 224 and the tip end portion 222 of the right side surface 202 are formed as portions of the continuously spatial envelope 228.

In view of the foregoing description, it is apparent that the present invention provides a new and improved power steering gear assembly 10 for use in turning steerable vehicle wheels 50 and 52. The power steering gear assembly 10 may include a piston 20 which cooperates with a motor cylinder 16 to form motor cylinder chambers 22 and 24. A valve assembly 28 is operable to control a flow of fluid to the motor cylinder chambers 22 and 24. A follow-up member 30 is connected with the valve assembly 28 and the piston 20 to effect operation of the valve assembly 28 as a function of movement of the piston. A pinion gear 48 is disposed in meshing engagement with a series 44 of rack teeth connected with the piston.

In accordance with one of the features of the invention, a tooth space 94 formed between rack teeth 76 and 80 has fillets 132 and 136 having radii 130 and 134 which are not symmetrical with respect to the central axis 104 of the tooth space 94. In accordance with another feature of the invention, a tooth 190 of the pinion gear 48 has a side surface 216 or 230 area which is offset from a spatial envelope 212 or 228 of tip and root end portions 208 and 210 or 222 and 224 of a side surface of the tooth 190 of the pinion gear 48.

In view of the description above, those skilled in the art will become aware of modifications and changes which may be made in the present invention, and such modifications and changes are intended to be covered by the appended claims. The various features of the invention may be used together, as disclosed herein. Alternatively, the various features may be used separately or in combination with one or more features from the prior art.

Having described the invention, the following is claimed:

1. A power steering gear assembly for use in turning steerable vehicle wheels, said power steering gear assembly comprising
a housing having a motor cylinder,
a piston disposed in said motor cylinder and cooperating with said motor cylinder to form first and second motor cylinder chambers,
a valve assembly connected with said housing and operable to control a flow of fluid to said first and second motor cylinder chambers,
a follow-up member connected with said valve assembly and said piston to effect operation of said valve assembly as a function of movement of said piston, said follow-up member extending into an opening formed in a first end portion of said piston,
a series of rack teeth connected with said piston, said series of rack teeth including at least a portion of a first rack tooth at an end of said series of rack teeth disposed adjacent to the first end portion of said piston and a second rack tooth disposed adjacent to said first rack tooth and spaced from said first rack tooth in a direction away from the first end portion of said piston, a first tooth space formed between said first and second rack teeth and having a root portion which includes a first fillet with a continuously curving surface which extends from a flank surface of said first tooth toward said second tooth and a second fillet having a continuously curving surface which extends from a flank surface of said second tooth toward said first tooth, said continuously curving surface of said first fillet having a larger radius of curvature than said continuously curving surface of said second fillet, and
a pinion gear disposed in meshing engagement with said rack teeth.

2. A power steering gear assembly as set forth in claim 1 wherein said first tooth space is formed between said first and second rack teeth and has a central axis which extends transverse to a longitudinal central axis of said series of rack teeth, said continuously curving surfaces of said first and second fillets having centers of curvature which are disposed between said central axis of said first tooth space and said second rack tooth.

3. A power steering gear assembly as set forth in claim 1 wherein said series of rack teeth includes a third rack tooth disposed at an end of said series of rack teeth opposite from said first rack tooth and a fourth rack tooth disposed adjacent to said third rack tooth and spaced from said third rack tooth in a direction toward the first end portion of said piston, a second tooth space formed between said third and fourth rack teeth and having a root portion which includes a third fillet with a continuously curving surface which extends from a flank surface of said third tooth toward said fourth tooth and a fourth fillet having a continuously curving surface which extends from a flank surface of said fourth tooth toward said firth tooth, said continuously curving surface of said third fillet having the same radius of curvature as said continuously curving surface of said fourth fillet.

4. A power steering gear assembly as set forth in claim 3 wherein said second tooth space formed between said third and fourth rack teeth has a central axis which extends transverse to the longitudinal central axis of said series of rack teeth, said continuously curving surfaces of said third and fourth fillets having centers of curvature which are disposed on opposite sides of said central axis of said second tooth space.

5. A power steering gear assembly as set forth in claim 1 wherein said pinion gear includes a series of pinion teeth, one of said pinion teeth having first and second side surfaces, said first side surface of said one of said pinion teeth having a tip end portion and a root end portion which are formed as portions of a first curve having a continuously curving spatial envelope, said first side surface of said one of said pinion teeth having an intermediate portion which is disposed between said tip and root end portions of said first side surface, said intermediate portion of said first side surface of said one of said pinion teeth being offset from the continuously curving spatial envelope of said first curve in a direction away from said second side surface of said one of said pinion teeth, said second side surface of said one of said pinion teeth having a tip end portion and a root end portion which are formed as portions of a second curve having a continuously curving spatial envelope, said second side surface of said one of said pinion teeth having an intermediate portion which is disposed between said tip and root end portions of said second side surface, said intermediate portion of said second side surface of said one of said pinion teeth being offset from the continuously curving spatial envelope of said second curve in a direction away from said first side surface of said one of said pinion teeth.

6. A power steering gear assembly as set forth in claim 5 wherein said tip end portion of said first side surface of said one of said pinion teeth is at least partially formed as a first series of tip end portion involute curves, said root end portion of said first side surface of said one of said pinion teeth is at least partially formed as a second series of root end portion involute curves, said first series of tip end portion involute curves includes involute curves having base circle diameters which are different than base circle diameters of said first series of root end portion involute curves, said tip end portion of said second side surface of said one of said pinion teeth is at least partially formed as a second series of tip end portion involute curves, said root end portion of said second side surface of said one of said pinion teeth is at least partially formed as a second series of root end portion involute curves, said second series of tip end portion involute curves includes involute curves having base circle diameters which are different than base circle diameters of said second series of root end portion involute curves.

7. A power steering gear assembly as set forth in claim 5 wherein said pinion has a pitch diameter which progressively increases with angular displacement of said pinion gear through a predetermined arcuate distance.

8. A power steering gear assembly for use in turning steerable vehicle wheels, said power steering gear assembly comprising:
a housing having a motor cylinder,
a piston disposed in said motor cylinder and cooperating with said motor cylinder to form first and second motor cylinder chambers,
a valve assembly connected with said housing and operable to control a flow of fluid to said first and second motor cylinder chambers,
a follow-up member connected with said valve assembly and said piston to effect operation of said valve assembly as a function of movement of said piston, said follow-up member extending into an opening formed in a first end portion of said piston,
a series of rack teeth connected with said piston, and a pinion gear disposed in meshing engagement with said rack teeth,
said pinion gear includes a series of pinion teeth, one of said pinion teeth having first and second side surfaces, said first side surface of said one of
said pinion teeth having a tip end portion and a root end portion which are formed as portions of a first curve having a continuously curving spatial envelope, said first side surface of said one of said pinion teeth having an intermediate portion which is disposed between said tip and root end portions of said first side surface, said intermediate portion of said first side surface of said one of said pinion teeth being offset from the continuously curving spatial envelope of said first curve in a direction away from said second side surface of said one of said pinion teeth, said second side surface of said one of said pinion teeth having a tip end portion and a root end portion which are formed as portions of a second curve having a continuously curving spatial envelope, said second side surface of said one of said pinion teeth having an intermediate portion which is disposed between said tip and root end portions of said second side surface, said intermediate portion of said second side surface of said one of said pinion teeth being offset from the continuously curving spatial envelope of said second curve in a direction away from said first side surface of said one of said pinion teeth.

9. A power steering gear assembly as set forth in claim 8 wherein said series of rack teeth includes a first rack tooth and a second rack tooth disposed adjacent to said first rack tooth, a first tooth space formed between said first and second rack teeth and having a root portion which includes a first fillet with a continuously curving surface which extends from a flank surface of said first rack tooth toward said second rack tooth and a second fillet having a continuously curving surface which extends from a flank surface of said second rack tooth toward said first rack tooth, said continuously curving surface of said first fillet having a larger radius of curvature than said second fillet.

10. A power steering gear assembly as set forth in claim 9 wherein said tip end portion of said first side surface of said one of said pinion teeth is at least partially formed as a first series of involute curves, said root end portion of said first side surface of said one of said pinion teeth is at least partially formed as a first series of root end portion involute curves, said first series of tip end portion involute curves includes involute curves having base circle diameters which are different than base circle diameters of said first series of root end portion involute curves, said tip end portion of said second side surface of said one of said pinion teeth is at least partially formed as a second series of involute curves, said root end portion of said second side surface of said one of said pinion teeth is at least partially formed as a second series of root end portion involute curves, said second series of tip end involute curves includes involute curves having base circle diameters which are different than base circle diameters of said second series of root end portion involute curves.
